(19) United States
(12) Patent Application Publication
(10) Pub. No.: US 2024/0047766 A1
(43) Pub. Date: Feb. 8, 2024

(54) SYSTEMS AND METHODS FOR A MODULAR BATTERY WITH VERTICAL EXPANSION CAPACITY

(71) Applicant: MCK671 LLC, Wilmington, DE (US)

(72) Inventor: Michael Carl McConnell, Houston, TX (US)

(73) Assignee: MCK671 LLC, Wilmington, DE (US)

(21) Appl. No.: 18/228,963

(22) Filed: Aug. 1, 2023

Related U.S. Application Data
(60) Provisional application No. 63/394,345, filed on Aug. 2, 2022.

(51) Int. Cl. H01M 10/42; H01M 10/44; H01M 50/204; H01M 50/251; H01M 50/258; H01M 10/663; H01M 10/613; H01M 10/627; H01M 10/63; H01M 10/6563; H02J 7/00

(52) U.S. Cl. CPC H01M 10/425; H01M 10/441; H01M 50/204; H01M 50/251; H01M 50/258; H01M 10/663; H01M 10/613; H01M 10/627; H01M 10/63; H01M 10/6563; H02J 7/0013; H01M 2220/10; H01M 2010/4271

(57) ABSTRACT

A modular battery system includes a plurality of battery modules positioned on a different floor of an enclosure. Each of the plurality of battery modules includes a plurality of battery arrays of rechargeable batteries. A controller is configured to select one of the plurality of battery modules for charging or discharging. A power converter is positioned on a different floor of the enclosure from each of the plurality of battery modules. The power converter is configured to convert an alternating current (AC) input to a direct current (DC) input and to switch the DC input to the selected one of the plurality of battery modules for charging.

### RELATED APPLICATION

This application claims priority under 35 U.S.C. § 119 to U.S. Provisional Application No. 63/394,345, entitled, “SYSTEMS AND METHODS FOR A MODULAR BATTERY WITH VERTICAL EXPANSION CAPACITY,” filed Aug. 2, 2022, and hereby expressly incorporated by reference herein.

### FIELD

This application relates to battery modules and more particularly, to storage systems for battery modules.

### BACKGROUND OF THE INVENTION

Demand for battery energy storage systems (BESS) is rising due to the huge growth in solar, wind, and other renewable energy projects that are not able to produce energy consistently. For example, wind farms can only produce energy when the wind is blowing and solar panels can only produce energy when the sun is shining. High capacity storage systems can help control fluctuations in power output of such renewable energy projects. The energy can be stored in the high capacity storage systems and released when needed, e.g., to adjunct facilities. In addition, excess capacity of the storage system may be stored and then sold to a marketplace grid when demand is highest, maximizing output revenues. So the high capacity storage systems help to stabilize the variability of solar and wind power and may provide increased revenue from the renewable energy.

Currently, most BESS projects are located in areas where land is readily available and geographical considerations are not an issue. However, as the demand for energy storage increases, battery energy storage systems will need to be installed in more urban, densely populated areas. Unlike current BESS projects in wide-open spaces developed horizontally, BESS projects located in urban areas must consider a new approach. Most urban areas do not have the luxury of ample land at lower property costs. However, for large facilities having significant power requirements, current BESS projects are quite expansive geographically, making it difficult to locate in urban areas, as well as difficult to access for maintenance or to add capacity.

Thus, there is a need for a modular battery system that is expandable with a lower geographic footprint. Moreover, the modular battery system needs to provide ease of maintenance and access to both the internal and external portions of the modular battery system. The modular battery system further needs to be able to expand capacity as needed, and even reduce capacity, or sell over capacity back into a market or microgrid. Thus, there is a need for an improved facility for modular battery systems with these and/or alternate advantages.

### SUMMARY OF THE INVENTION

In one or more aspects herein, a modular battery system includes a plurality of battery modules electrically coupled in parallel, wherein each battery module of the plurality of battery modules is positioned on a different floor of an enclosure and wherein each battery module of the plurality of battery modules includes a plurality of battery arrays of rechargeable batteries. The modular battery system also includes a controller configured to select one of the plurality of battery modules for charging or discharging.

In one or more aspects herein, a modular battery system includes a plurality of battery modules, wherein each battery module of the plurality of battery modules is positioned on a different floor of an enclosure and wherein each battery module of the plurality of battery modules includes a plurality of battery arrays of rechargeable batteries. The modular battery system also includes a controller configured to select one of the plurality of battery modules for charging or discharging, wherein the controller is positioned on a different floor of the enclosure from the plurality of battery modules.

In one or more aspects herein, a method for operating a modular battery system includes electing by a controller one of a plurality of battery modules, wherein each battery module of the plurality of battery modules is positioned on a different floor of an enclosure and wherein each battery module of the plurality of battery modules includes a plurality of battery arrays of rechargeable batteries. The method also includes switching an AC input from a power generator to a first one of a plurality of inverters associated with the selected one of the plurality of battery modules; converting the AC input to a DC input by the first one of the plurality of inverters; and charging the plurality of battery arrays in the selected one of the plurality of battery modules with the DC input.

In one or more of the above aspects, the modular battery system includes a power converter configured to convert an alternating current (AC) input to a direct current (DC) input and to switch the DC input to the selected one of the plurality of battery modules.

In one or more of the above aspects, the power converter is positioned on a different floor of the enclosure from each of the plurality of battery modules.

In one or more of the above aspects, the power converter includes a plurality of inverters, wherein each inverter of the plurality of inverters is associated with a different one of the plurality of battery modules and a plurality of switches, wherein each switch of the plurality of switches is configured to couple the AC input to one of the plurality of inverters.

In one or more of the above aspects, the selected one of the plurality of battery modules includes a first set of the plurality of battery arrays and a second set of a plurality of battery arrays, wherein the first set and the second set are electrically coupled in parallel to a first one of the plurality of inverters associated with the selected one of the plurality of battery modules.

In one or more of the above aspects, at least a first circuit breaker is electrically coupled in series between the first set of a plurality of battery arrays and the associated first one of the plurality of inverters and at least a second circuit breaker is electrically coupled in series between the second set of the plurality of battery arrays and the associated first one of the plurality of inverters.

In one or more of the above aspects, the first set of the plurality of battery arrays includes at least two or more battery arrays electrically coupled in parallel, and the second set of the plurality of battery arrays includes at least two or more different battery arrays electrically coupled in parallel.

In one or more of the above aspects, a first intake duct extends down a first side of the enclosure, wherein the first intake duct is fluidly coupled to a first heating, ventilation, and air conditioning (HVAC) unit to receive a fluid for cooling the plurality of battery modules. A central duct fluidly couples to the first intake duct to remove air from the first intake duct, wherein the central duct is centrally located within the enclosure.

In one or more of the above aspects, the central duct is centrally located in the enclosure.

In one or more of the above aspects, the central duct is coupled to an exhaust vent at a roof of the enclosure for release of air from the central duct.

In one or more of the above aspects, the exhaust vent provides access for maintenance to the plurality of battery modules.

In one or more of the above aspects, the second intake duct extends down a second, different side of the enclosure, wherein the second intake duct is fluidly coupled to a second HVAC unit to receive fluid for cooling the plurality of battery modules.

In one or more of the above aspects, the second intake duct is fluidly coupled to the central duct, wherein the central duct is configured to remove air from the second intake duct.

In one or more of the above aspects, the first intake vent is positioned on the roof of the enclosure, wherein the first intake vent is fluidly coupled to the first intake duct and to the first HVAC unit, and a second intake vent is positioned on the roof of the enclosure, wherein the second intake vent is fluidly coupled to the second intake duct and to the second HVAC unit.

In one or more of the above aspects, the enclosure includes a display on an outside of the enclosure with an indication of a voltage or power level of the modular battery system.

In one or more of the above aspects, a method includes selecting by the controller a first one of the plurality of battery arrays in the selected one of the plurality of battery modules and charging the first one of the plurality of battery arrays in the selected one of the plurality of battery modules with the DC input.

In one or more of the above aspects, a method includes obtaining by the controller a power level for the plurality of battery arrays of each battery module of the plurality of battery modules.

In one or more of the above aspects, the controller uses the power level for the plurality of battery arrays of each battery module to select the one of the plurality of battery modules for charging by the DC input.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of description, embodiments are shown in the drawings, however, the embodiments are not limited to the precise arrangements and/or components shown herein. The embodiments may include less or more or alternate arrangements and/or components as described or shown in the following figures.

FIG. 1 illustrates an exemplary embodiment of an elevational view of a BESS facility with a vertical modular design in accordance with the present invention.

FIG. 2 illustrates a schematic block diagram of an exemplary embodiment of a top view of the BESS facility in accordance with the present invention.

FIG. 3 illustrates a schematic block diagram of an exemplary embodiment of a cross-sectional view of the BESS facility in accordance with the present invention.

FIG. 4 illustrates an exemplary embodiment of a block diagram of the BESS facility in accordance with the present invention.

FIG. 5 illustrates an exemplary embodiment of a display of the BESS facility in accordance with the present invention.

FIG. 6 illustrates an exemplary embodiment of a cross-sectional side view of the BESS facility in accordance with the present invention.

FIG. 7 illustrates an exemplary embodiment of a cross-sectional frontside view of the BESS facility in accordance with the present invention.

FIG. 8 illustrates an exemplary embodiment of a cross-sectional top view of the ground floor of the BESS facility in accordance with the present invention.

FIG. 9 illustrates an exemplary embodiment of a cross-sectional top view of one of the plurality of modules of the BESS facility in accordance with the present invention.

FIG. 10 illustrates a schematic block diagram of an exemplary embodiment of the electrical system of the BESS facility in accordance with the present invention.

FIG. 11 illustrates a schematic block diagram of an exemplary embodiment of the electrical system in more detail for one of the plurality of modules.

FIG. 12 illustrates a schematic block diagram of an exemplary embodiment of a set of battery arrays in more detail in accordance with the present invention.

### DETAILED DESCRIPTION OF THE INVENTION

The word “exemplary” or “embodiment” is used herein to mean “serving as an example, instance, or illustration.” Any implementation or aspect described herein as “exemplary” or as an “embodiment” is not necessarily to be construed as preferred or advantageous over other aspects of the disclosure. Likewise, the term “exemplary” or “embodiment” does not require that such aspect of the disclosure is included in each embodiment or in the claims.

Unlike isolated or rural land for conventional installations, BESS projects in urban areas have geographic constraints and higher visibility to the public. For a more efficient use of land, in an embodiment, a BESS facility is described herein that includes a vertical modular design with a plurality of floors. The number of floors may be planned and added to the BESS facility to achieve various power storage requirements, such as 100 MW to 400 MW to 800 MW or more.

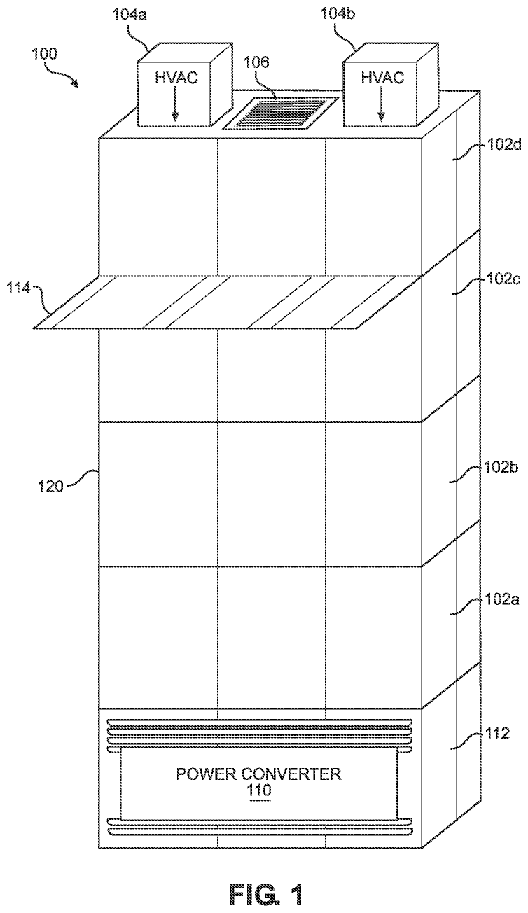

FIG. 1 illustrates an exemplary embodiment of an elevational view of a BESS facility 100 with a vertical modular design in accordance with the present invention. The BESS facility 100 includes a plurality of floors or modules 102a-d within one building or enclosure 120. Each of the plurality of modules 102a-d is positioned on a different floor of the enclosure 120 and includes a plurality of battery arrays. Each battery array in the plurality of battery arrays includes a plurality of rechargeable batteries that are charged by an electrical direct current (DC) from a generator or other power source. The BESS facility 100 may provide power as required to operate various types of powered systems, such as a machine or a vehicle or provide power to a home, building, data center or other uses.

The power output of the BESS facility 100 may be varied by varying the number of modules 102a-d, the number of battery arrays on one or more of the plurality of modules 102a-d, and/or the configuration of the battery arrays. The specific configuration of the battery arrays may be based on the power requirements of expected usage or operation of the powered system. For example, a battery array may be configured to a specific powered system by installing and/or removing rechargeable batteries from the battery array based on the power requirements of the powered system. Moreover, the battery modules 102a-d in the BESS facility 100 may be added or removed as required. For example, the BESS facility 100 may include one, two, three or more battery modules 102a-d depending on the required battery storage and/or power output. Each battery module 102 may be approximately one floor or story of the BESS facility 100. For example, each battery module 102a-d may reside one a floor of the enclosure 120 that is 8 feet to 10 feet tall and 20 feet to 40 feet wide. However, these dimensions are exemplary and other dimensions may be implemented depending on the application and usage.

The modules 102a-d are preferably “stacked” on top of each other within the enclosure 120. The BESS facility 100 can thus provide expandable capacity in a vertical direction, e.g., the ability to expand upward in a stackable design. This vertical stacking of the modules 102a-d reduces the need for land requirements. For example, one or more modules 102 or battery arrays within a module 102 may be added to expand capacity to meet the power requirements, e.g., of a powered system or a microgrid or to provide power during hours of higher power consumption.

In an embodiment, the one or more battery arrays of rechargeable batteries within one module 102a-d are coupled in series. A programmable logic controller (PLC) may be used to couple the batteries in the one or more arrays in the battery modules 102a-d or between the battery modules 102a-d.

The BESS facility 100 further includes a power converter 110, such as an inverter/transformer, at a base floor 112 of the stackable modules 102a-d. The battery arrays in the modules 102a-d are coupled to the power convertor 110 (e.g., inverter/transformer) at the base 112 of the BESS facility 100. This reduces the need for multiple inverters/transformers, and also reduces the length of electrical conductors. The BESS facility 100 may thus have reduced equipment costs and maintenance due to reduction in required equipment.

The BESS facility 100 further includes one or more heating, ventilation, and air conditioning (HVAC) units 104a-b. The one or more HVAC units 104a-b may be external or internal to the enclosure 120. The HVAC units 104a-b provide cooling to the BESS facility 100 through a series of pipes or ducts or other conduits. The BESS facility 100 further includes a central duct positioned in a central location to the modules 102a-d within the enclosure 120. The central duct includes an exhaust vent 106 in a top or roof of the enclosure 120 for the release of air and/or exhaust. The exhaust vent 106 may release the exhaust into the atmosphere or may be attached to a return vent or conduit in the one or more of the HVAC units 104a-b. In addition, the exhaust vent 106 may be removable to provide access to a service tunnel. The service tunnel may include the central duct or be an open space or central void around the central duct. The BESS facility 100 may include a mezzanine flooring system for optimized HVAC and fire suppression. The HVAC system may include a geothermal HVAC system for added efficiency and additional green efficiency.

For convenience of a technician, the battery module system 100 may include a platform or shelf 114. The user may then access and communicate with the BESS facility 100 for maintenance or upgrades. The BESS facility 100 may further include custom aesthetics applied to an exterior, such as on an external side and/or on a roof of the enclosure 120 (e.g., such as a clock tower, battery meter, green energy signage, etc.).

The BESS facility 100 is thus expandable (e.g., based on requested kilowatt and/or megawatt/hour rating) by adding additional floors or modules 102a-d in a vertical stack. This vertical stack significantly lowers the geographic footprint requirement of the BESS facility 100. This modular approach of the BESS facility 100 may be implemented with existing/distressed/new commercial buildings, hospitals, universities, etc. The design also reduces the number of needed inverters, transformers, and number of electrical conductors. Additionally, it provides ease of maintenance from the outside and the inside of the modular stacks, but also allows the end user to add capacity as needed, and even reduce capacity, or sell over capacity back into a market or microgrid.

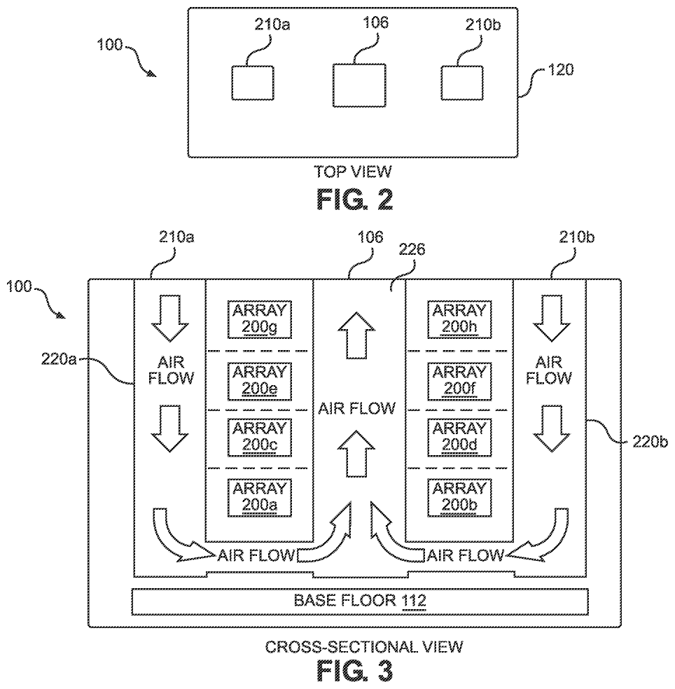

Referring now to FIGS. 2-3, FIG. 2 illustrates a schematic block diagram of an exemplary embodiment of a top view of the roof of the BESS facility 100, and FIG. 3 illustrates a schematic block diagram of an exemplary embodiment of a cross-sectional view of a side of the BESS facility 100. As seen in FIGS. 2-3, the BESS facility 100 includes one or more intake vents 210a-b coupled to intake ducts 220a-b. The first and second intake vents 210a-b are positioned on a first side and a second, opposing side of the BESS facility 100, respectively. A central duct 226 is coupled to the exhaust vent 106 and extends through a center portion of the enclosure 120. The intake ducts 220a-b are fluidly coupled to the exhaust central duct 226, e.g., below the lowest floor including a module 102a-d.

In one example, the first HVAC unit 104a is fluidly coupled to the first intake vent 210a to provide air flow into the first intake duct 220a and extends down at least a first side of the modules 102a-d in the enclosure 120. The air (or other cooling fluid) from the HVAC unit 104a enters the first intake vent 210a and flows through the first intake duct 220a to cool the modules 102a-d.

In this embodiment, the BESS facility 100 also includes a second intake vent 210b for airflow from a second HVAC unit 104b. The second intake vent 210b is coupled to a second intake duct 220b that is positioned and extends down at least a second side of the modules 102a-d in the enclosure 120. Though two intake vents 210a-b and intake ducts 220a-b are illustrated, a single intake vent 104 and duct 220 or additional intake vents 104 and ducts may also be implemented in the BESS facility 100.

The first and second intake ducts 220a-b are coupled to the central duct 226. The central duct 226 is positioned in a central location within the enclosure 120, e.g. between the first intake duct 220a and the second intake duct 220b. The central duct 226 is fluidly coupled to the exhaust vent 106 at the roof of the enclosure 120 for the release of exhaust. The exhaust vent 106 may release the exhaust into the atmosphere or may be attached to a return vent or conduit to the one or more HVAC units 104a-b.

The central duct 226 may also be situated in a center of, or centrally to, the battery arrays 200a-h in the modules 102a-d. The central duct 226 or a void or space around the central duct 226 may be accessed through the exhaust vent 106. Thus, the exhaust vent 106 provides a service tunnel entrance to access the modules 102a-d for maintenance. For example, a ladder, stairs, or elevator accessible through the exhaust vent 106 may provide access to the various modules 102a-d.

The modules 102a-d each include one or more battery arrays 200. For example, first module 102a includes battery arrays 200a-b, second module 102b includes battery arrays 200c-d, third module 102c includes battery arrays 200e-f, and fourth battery module 102d includes battery arrays 200g-h. Though the modules 102a-d are shown as including two battery arrays 200, the modules 102a-d may include only one battery array 200 or three or more battery arrays 200, or the different modules 102a-d may include a different number of battery arrays 200.

In one embodiment, the battery arrays 200 include a plurality of rechargeable batteries, such as lithium ion batteries. The battery arrays 200 may be coupled in series (e.g., within a module 102) or in parallel (e.g., between different modules 102).

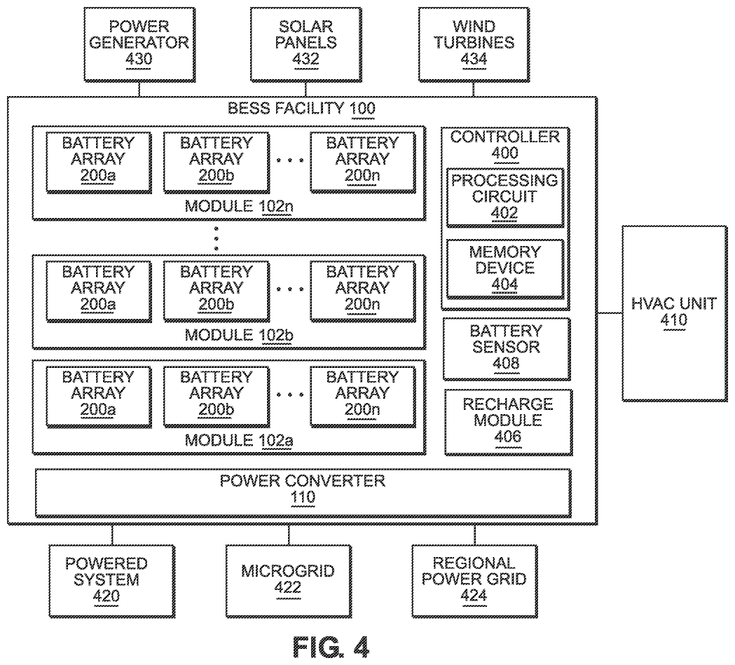

FIG. 4 illustrates an exemplary embodiment of a block diagram of the BESS facility 100 in accordance with the present invention. The BESS facility 100 includes a controller 400 having at least one processing circuit 402 and at least one memory device 404 and is configured to control the one or more functions of the BESS facility 100. The memory device 404 is a non-transitory, processor readable medium that stores programs, code, states, instructions and/or data which when executed or processed by the processing circuit, causes the BESS facility 100 to perform one or more functions described herein. The processing circuit 402 includes one or more processing devices on one or more printed circuit boards, including one or more of a microprocessor, micro-controller, digital signal processor, video graphics processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions.

In one embodiment, the controller 400 manages and monitors the input voltage and/or input current at power converter 110 and may balance the power input from the power converter 110 to the various modules 102a-n and/or to the various battery arrays 200a-n within a module 102a-n. The controller 400 may also manage the power output and current discharge of the various modules 102a-n and/or battery arrays 200a-n to the power converter 110.

The power convertor 110 converts power received from external sources, e.g., such as from a power generator 430, solar panels 432, and/or wind turbines 434. The recharge module 406 uses the externally generated power to charge the batteries in the one or more battery arrays 200a-n in the battery modules 102a-n. The power converter 110 also converts power from the batteries for transfer to external power consumers, e.g., a powered system 420, a microgrid 422 and/or a regional power grid 424. The power convertor 110 converts output direct current (DC) from the batteries to output alternating current (AC) and/or increases or decreases the voltage level of the output AC current before providing the output AC current to an external powered system or power consumer.

The battery sensor 408 determines a voltage and/or power level of the battery arrays 200a-n in the modules 102a-n and provides alerts when one or more batteries in a battery array 200 are fully charged or when one or more batteries in a battery array 200 is low on power. In another example, the battery sensor 408 may determine a voltage and/or power level of the combined plurality of the modules 102a-n and provide alerts when the plurality of battery arrays 200a-n in the modules 102a-n are fully charged or when the plurality of battery arrays 200a-n in the modules 102a-b are low on power.

The BESS facility 100 may be coupled to a powered system 420, e.g., that may include one or more of: a vehicle, house, factory, data center, machine, marine vessel, ship, boat, rail system, etc. For example, the BESS facility 100 may power larger marine vessels or other forms of transportation where space is extremely limited, but are able to accommodate the tower(s). Examples may include emergency shore power while a marine vessel is underway, or at dock under a power outage situation. In another example, the BESS facility 100 may be used as a primary or backup power to a data center in which power operation is critical. In another example, the BESS facility 100 may be used to provide the primary or backup power to a hospital or university or company building. The BESS facility 100 may further be coupled to a microgrid 422 or a regional power grid 424. The BESS facility 100 may then provide over capacity for sale back into the power market.

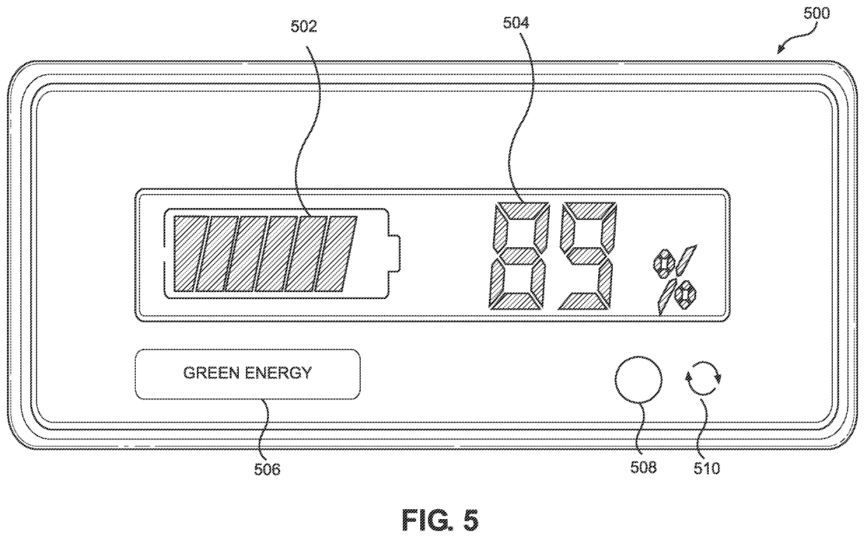

FIG. 5 illustrates an exemplary embodiment of a display 500 of the BESS facility 100 in accordance with the present invention. The display 500 may include a graphical user interface (GUI) that includes a battery meter indicator 500. The controller 400 may determine the voltage and/or power level of the BESS facility 100 from the battery sensor 408 and generate the GUI of the battery meter indicator that indicates a voltage and/or power level of the BESS facility 100. A first level indicator 502 may be a bar graph or other type of graph that illustrates the voltage and/or power level. A second level indicator 504 may be a numerical percentage of the voltage and/or power level. The display 500 may include one or more types of such power level indicators 500, 502. Additionally or alternatively, the voltage and/or power level of each of the plurality of modules 102a-b may be included in the display 500.

The display 500 may include other GUIs, such as a Green Energy indicator 506. The Green Energy indicator 506 may be displayed when green energy, such as solar or wind energy, is charging the BESS facility 100. A charging GUI 508 may indicate when the BESS facility 100 is actively charging. An overcapacity GUI 510 may indicate when the BESS facility 100 is overcapacity and providing excess power to a power market or microgrid. The display 500 may include other indicators and information as well.

The display 500 in one example is positioned on an external side of the enclosure 120 in a position and size to be visible to persons in the vicinity of the BESS facility 100. The display 500 may inform the persons in the vicinity of the proper operation of the BESS facility 100 as well as provide an advertisement for green energy. The display 500 allows end users and private citizens the ability to see the battery towers at work (charging and discharging). For example, the display 500 may be 1-2 feet in height and 3-4 feet in width for a one story tower that is 10 feet to 15 feet tall. In another example, the display 500 may be a 12 feet in height and feet in width (e.g., the size of a billboard) for a four story tower that is 40 to 50 feet tall. However, these dimensions are exemplary and other dimensions may be implemented depending on the application and usage.

In an embodiment, the BESS facility 100 may include other design elements to enhance the appearance of the enclosure 120. For example, the top of the enclosure 120 may include a clock, much like a university clock tower, or a bell tower. The BESS facility 100 may have other custom aesthetics applied to the exterior in addition to the clock/bell tower, battery meter, and/or green energy signage.

Intelligent battery software uses algorithms to coordinate energy production and computerized control systems are used to decide when to store energy or to release it to the grid. Energy is released from the battery storage system during times of peak demand, keeping costs down and electricity flowing.

### Second Embodiment of the BESS Facility

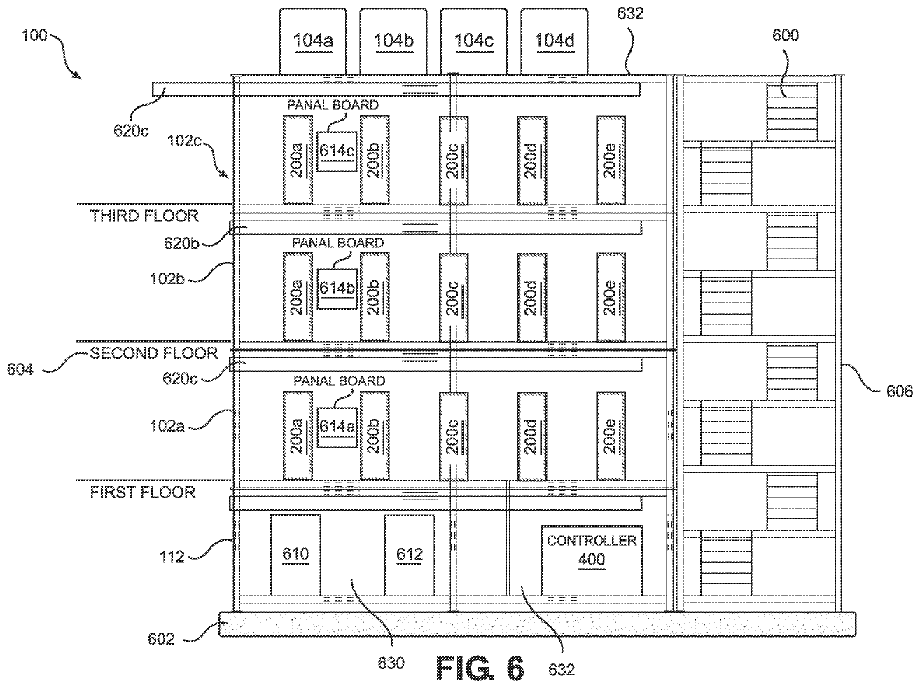

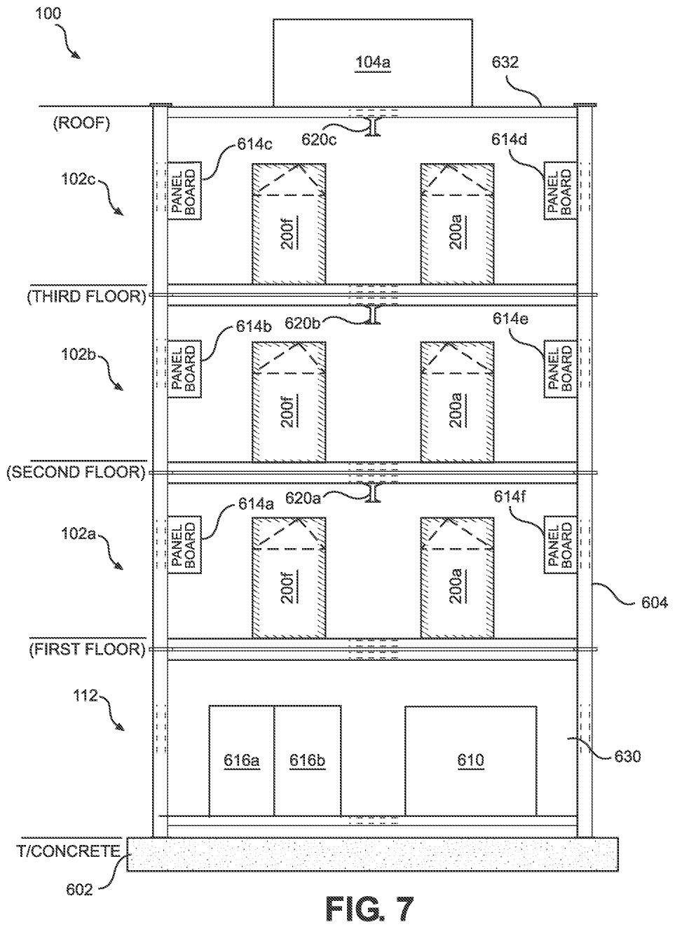

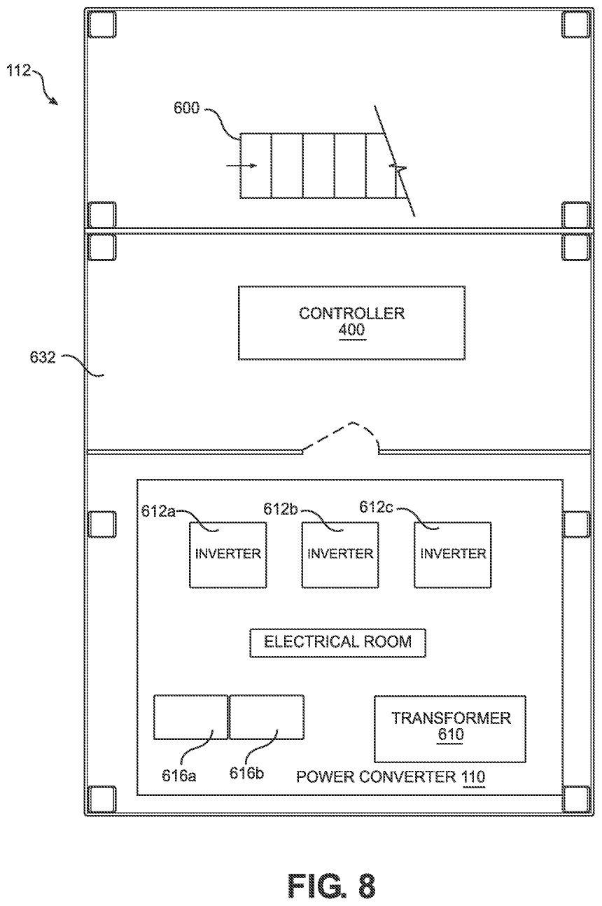

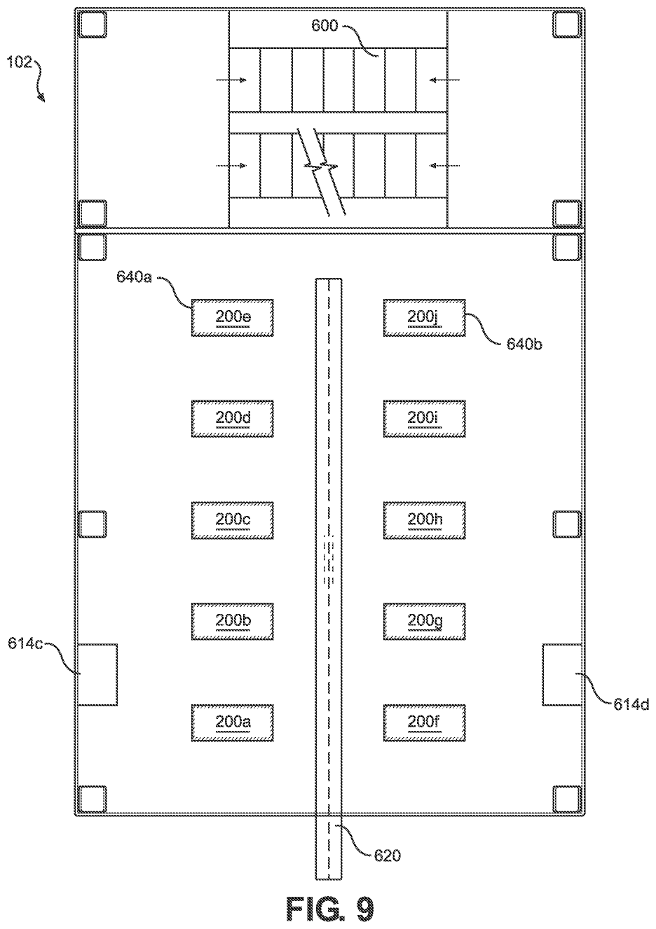

FIGS. 6-9 illustrate schematic block diagrams of another exemplary embodiment of a BESS facility 100 in accordance with the present invention. FIG. 6 illustrates a cross-sectional side view of the BESS facility, and FIG. 7 illustrates a cross-sectional frontside view of the BESS facility 100. FIG. 8 illustrates a cross-sectional top view of the ground floor 112 of the BESS facility 100, and FIG. 9 illustrates a cross-sectional top view of one of the plurality of modules 102a-c of the BESS facility 100.

In this second embodiment, the BESS facility 100 again includes a plurality of floors or modules 102a-c and a ground floor 112. The BESS facility 100 includes a concrete or other type of foundation 602 and stairs 600 from the ground floor 112 to each of the modules 102a-c and to the roof 632. In this embodiment, the stairs 600 are positioned on a back side 606 of the BESS facility 100. The frontside 604 or opposing side of the BESS facility may include the display 500 or other design elements. The roof 632 of the enclosure 120 may include one or more HVAC units 104a-d, e.g., such as the condenser portion of the HVAC units 104a-d. In an embodiment, a monorail 620c may extend from the ceiling of the top module 102c outwards from a frontside 604 of the building. Each of the ceilings of the modules 102a-c may include such a monorail 620a-c. The monorails 620a-c provide another option, other than the stairs 600 or an elevator, for the installation and/or removal of batteries, equipment, tooling, etc. The monorails 620a-c may be used to raise and lower heavy equipment from the elevated floors.

Referring to FIG. 8, the ground floor 112 includes components of the power converter 110, such as one or more transformers 610, one or more inverters 612a-c, and one or more switches 616a-b. These components of the power converter 110 may be positioned in a first, electrical room 630 on the ground floor 112. The ground floor 112 may also include a second, control room 632, that includes at least the controller 400. For example, the controller 400 may include one or more of a desktop computer, laptop, smart phone, or other user device. The control room 632 may also include other sensors or modules, such as the battery sensor 408 and/or recharge module 406.

Referring now to FIG. 9, the plurality of modules 102a-c include one or more sets 640a-b of battery arrays 200a-j, wherein each battery array 200a-j may be positioned on a separate rack. The battery arrays 200a-j each include a plurality of rechargeable batteries that are connected in series and/or in parallel within the array. Each of the modules 102a-c includes one or more electrical panels 614a-f. The electrical panels 614a-f couple the battery arrays 200 to the power converter 110 on the first floor 110.

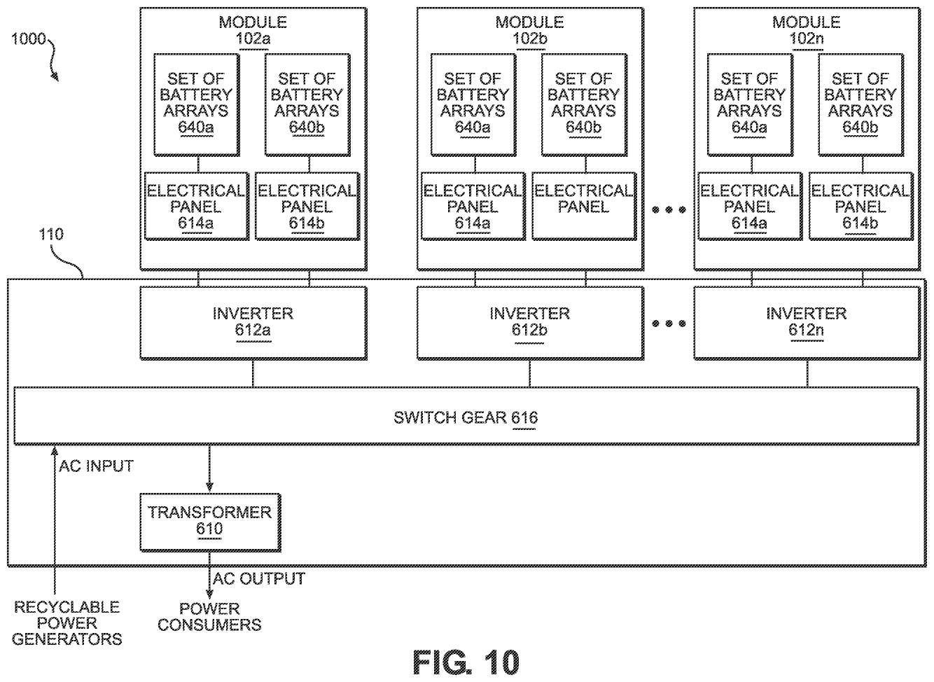

FIG. 10 illustrates a schematic block diagram of an exemplary embodiment of the electrical system 1000 of the BESS facility 100 in accordance with the present invention. This electrical system 1000 may be implemented in one or more embodiments of the BESS facility described herein. The electrical system 1000 includes the power converter 110 that is positioned on a ground floor 112. The power converter 110 includes a transformer 610, switch gear 616, and one or more inverters 612a-n. In one embodiment, at least one inverter 612a-n is dedicated to an associated one of the modules 102a-n. The inverters 612a-c are operable to convert between alternating current (AC) and direct current (DC) when charging or discharging the modules 102a-n.

The modules 102a-n are each separated on a different floor of the BESS facility 100. The battery arrays 200 at each module 102a-n may be separated into one or more sets 640a-b, with one or more battery arrays 200 in each set 640. In one embodiment, at least one electrical panel 614a-b is dedicated to each set of battery arrays 640a-b.

In use, the BESS facility 100 receives AC input power generated by recyclable power generators and/or other types of power generators. The controller 400 selects one or more modules 102a-n based on the available power levels in each of the modules 102a-n. In another embodiment, the controller 400 may further specify one or more sets of battery arrays 640 or one or more individual battery arrays 200 within the selected module 102a-n. For example, the controller 400 may select a module 102a-n and then select a set 640a-b of battery arrays in the selected module 102a-n that has a power level that is lower than other sets 640a-b of battery arrays in the selected module 102a-n.

The switch gear 616 switches the AC input power to at least one inverter 612a-n, e.g., that is dedicated or associated with the selected module 102a-n. The dedicated inverter 612a-n converts the AC input power to DC input power. The DC input power is transmitted from the dedicated inverter 612 to the electrical panels 614a-b in the selected module 102a-n. The electrical panels 614a-b are then configured to transmit the DC input power to the set(s) of battery arrays 640 in the selected module 102a-n.

To power a consumer system, the controller 400 selects one or more modules 102a-n to output DC power based on the available power levels in each of the modules 102a-n. For example, the controller 400 may select the module 102a-n with a higher power level than the other modules 102a-n. In another example, the controller 400 may select a specific set 640a-b of battery arrays or even a specific battery array 200 based on the power levels of the individual sets 640a-b and/or battery arrays 200. The dedicated inverter 612a-n for the selected module 102a-n converts the DC output power to AC output power. The switch gear 616 switches the AC output power from the dedicated inverter 612a-n to the transformer 610. The transformer 610 converts the AC output power to a voltage level specified or required by the power consumer. The controller 400 may thus control the charging and discharging of the plurality of modules 102a-n to enhance efficiency and capacity of the BESS facility 100.

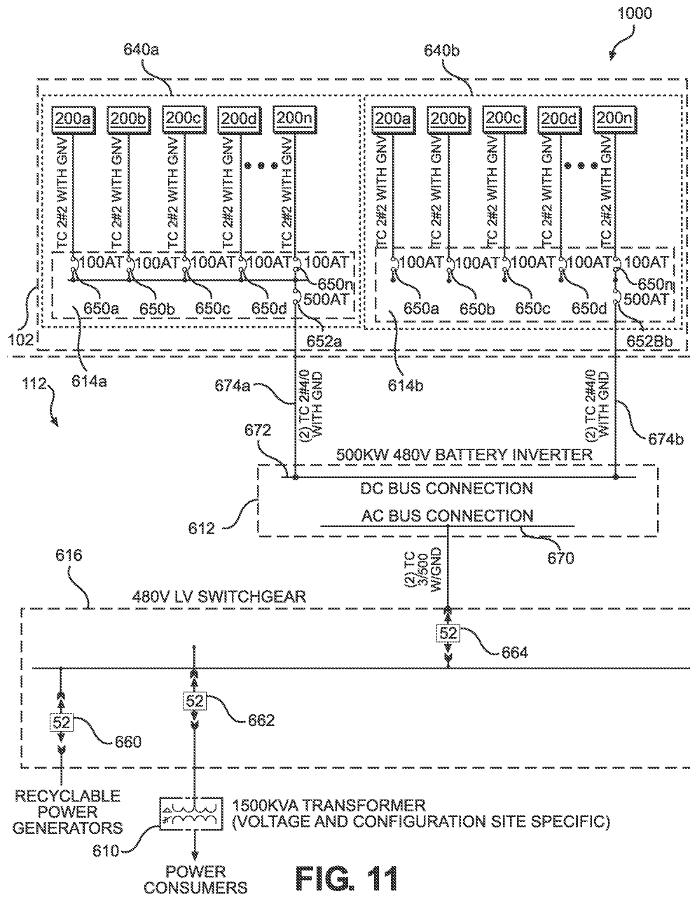

FIG. 11 illustrates a schematic block diagram of an exemplary embodiment of the electrical system 1000 in more detail for one of the plurality of modules 102 in accordance with the present invention. A first switch 660 of the switch gear 616 receives the AC input from one or more power generators. When the illustrated module 102 is selected for charging, the controller 400 controls the associated switch 664 with the selected module 102 to close and allow the AC input to flow to an AC bus connection 670 of the dedicated inverter 612 for the selected module 102. A DC bus connection 672 of the inverter 612 is coupled in parallel to the plurality of sets 640a-b of battery arrays in the selected module 102. The DC input from the inverter 612 is thus divided equally amongst the sets 640a-b of battery arrays in the selected module 102. The DC input flows over the lines 674a-b to the associated electrical panel 614a-b for each of the sets 640a-b of battery arrays. In an embodiment, the battery arrays 200a-n in a set 640a-b are electrically coupled in parallel to the associated electrical panel 614a-b and inverter 612. Thus, the DC input to one of the sets 640a-b is divided equally among the arrays 200a-n.

In an embodiment, each of the electrical panels 614a-b includes a set circuit breaker 652a-b in series with the line 674a-b between the inverter 612 and the battery arrays 200a-n. The set circuit breakers 652a-b are configured to trip or open at a predetermined set current limit. The predetermined set current limit depends on the number of battery arrays 200a-n and the capacity of the battery arrays 200a-n. In addition, an array circuit breaker 650a-n is positioned in series with each battery array 200a-n. The array circuit breakers 652a-b are configured to trip or open at a predetermined array current limit, wherein the array current limit is less than the set current limit. In one example, the predetermined array current limit is 100 Amps, and the set current limit for n=5 battery arrays is 500 Amps.

In another embodiment, one or more switches may be implemented alternatively or in addition to the array circuit breakers 650a-n and/or the set circuit breakers 652a-b. The controller 400 may then select individual sets 640a-b or arrays 200 for charging and discharging.

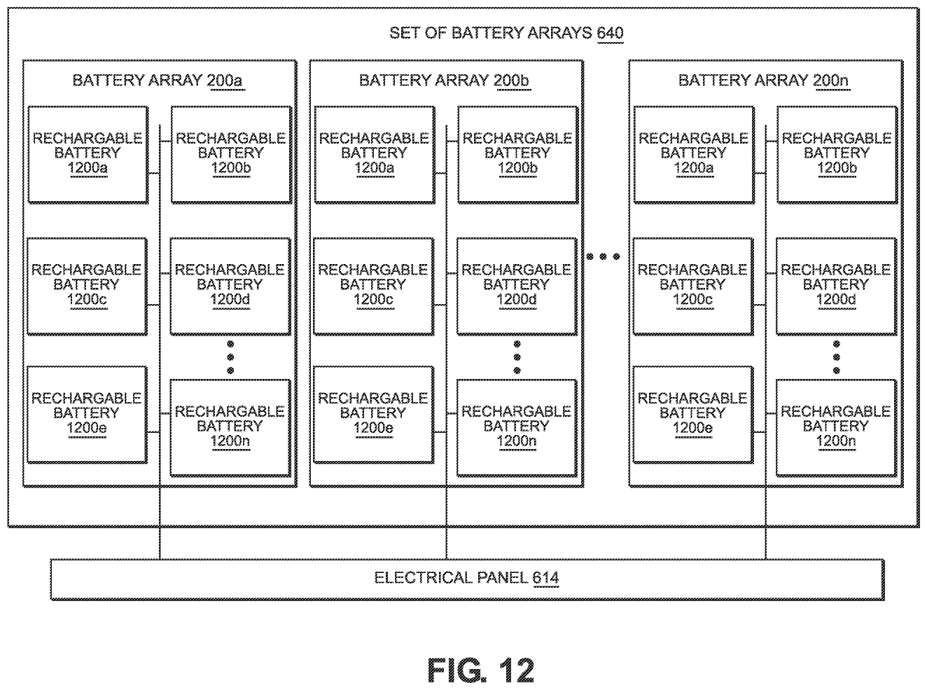

FIG. 12 illustrates a schematic block diagram of an exemplary embodiment of a set 640 of battery arrays 200a-n in more detail in accordance with the present invention. The set 640 may include one or more battery arrays 200a-n. The battery arrays 200a-n in the set 640 are electrically coupled in parallel but alternatively may be electrically coupled in series. Each of the battery arrays 200a-n includes a plurality of rechargeable batteries 1200a-n. The plurality of rechargeable batteries 1200a-n in a battery array 200a-n are electrically coupled in parallel such that the rechargeable batteries 1200a-n charge and discharge concurrently. In another embodiment, the rechargeable batteries 1200a-n may be electrically coupled in series.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

As may be used herein, the term “operable to” or “configurable to” indicates that an element includes one or more of circuits, instructions, modules, data, input(s), output(s), etc., to perform one or more of the described or necessary corresponding functions and may further include inferred coupling to one or more other items to perform the described or necessary corresponding functions. As may also be used herein, the term(s) “coupled,” “coupled to,” “connected to” and/or “connecting” or “interconnecting” includes direct connection or link between nodes/devices and/or indirect connection between nodes/devices via an intervening item (e.g., an item includes, but is not limited to, a component, an element, a circuit, a module, a node, device, network element, etc.). As may further be used herein, inferred connections (i.e., where one element is connected to another element by inference) includes direct and indirect connection between two items in the same manner as “connected to.”

Note that the aspects of the present disclosure may be described herein as a process that is depicted as a schematic, a flow chart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

In the foregoing specification, certain representative aspects have been described with reference to specific examples. Various modifications and changes may be made, however, without departing from the scope of the present invention as set forth in the claims. The specification and figures are illustrative, rather than restrictive, and modifications are intended to be included within the scope of the present invention. Accordingly, the scope of the invention should be determined by the claims and their legal equivalents rather than by merely the examples described. For example, the components and/or elements recited in any apparatus claims may be assembled or otherwise operationally configured in a variety of permutations and are accordingly not limited to the specific configuration recited in the claims. As such, the present teachings can be readily applied to other types of apparatuses and many alternatives, modifications, and variations will be apparent to those skilled in the art.

As may be used herein, the term “operable to” or “configurable to” indicates that an element includes one or more components, fasteners, or dimensions to perform one or more of the described or necessary corresponding functions and may further include inferred coupling to one or more other items to perform the described or necessary corresponding functions. As may also be used herein, the term(s) “coupled,” “coupled to,” “connected to” and/or “connecting” or “interconnecting” includes direct connection or and/or indirect connection through one or more other components. As may be used herein, the terms “substantially” and “approximately” provides an industry-accepted tolerance for its corresponding term and/or relativity between items.

As used herein, the terms “comprise,” “comprises,” “comprising,” “having,” “including,” “includes” or any variation thereof, are intended to reference a nonexclusive inclusion, such that a process, method, article, composition, or apparatus that comprises a list of elements does not include only those elements recited, but may also include other elements not expressly listed or inherent to such process, method, article, composition, or apparatus. Other combinations and/or modifications of the above-described structures, arrangements, applications, proportions, elements, materials, or components used in the practice of the present invention, in addition to those not specifically recited, may be varied, or otherwise particularly adapted to specific environments, manufacturing specifications, design parameters, or other operating requirements without departing from the general principles of the same.

Moreover, reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is intended to be construed under the provisions of 35 U.S.C. § 112(f) as a “means-plus-function” type element, unless the element is expressly recited using the phrase “means for” or, in the case of a method claim, the element is recited using the phrase “step for.”

1. A modular battery system, comprising:
a plurality of battery modules electrically coupled in parallel, wherein each battery module of the plurality of battery modules is positioned on a different floor of an enclosure and wherein each battery module of the plurality of battery modules includes a plurality of battery arrays of rechargeable batteries; and
a controller configured to select one of the plurality of battery modules for charging or discharging.

2. The modular battery system of claim 1, further comprising:
a power converter configured to convert an alternating current (AC) input to a direct current (DC) input and to switch the DC input to the selected one of the plurality of battery modules.

3. The modular battery system of claim 2, wherein the power converter is positioned on a different floor of the enclosure from each of the plurality of battery modules.

4. The modular battery system of claim 3, wherein the power converter comprises:
a plurality of inverters, wherein each inverter of the plurality of inverters is associated with a different one of the plurality of battery modules; and
a plurality of switches, wherein each switch of the plurality of switches is configured to couple the AC input to one of the plurality of inverters.

5. The modular battery system of claim 4, wherein the selected one of the plurality of battery modules includes a first set of the plurality of battery arrays and a second set of a plurality of battery arrays, wherein the first set and the second set are electrically coupled in parallel to a first one of the plurality of inverters associated with the selected one of the plurality of battery modules.

6. The modular battery system of claim 5, wherein at least a first circuit breaker is electrically coupled in series between the first set of a plurality of battery arrays and the associated first one of the plurality of inverters; and
wherein at least a second circuit breaker is electrically coupled in series between the second set of the plurality of battery arrays and the associated first one of the plurality of inverters.

7. The modular battery system of claim 6, wherein the first set of the plurality of battery arrays includes at least two or more battery arrays electrically coupled in parallel; and
wherein the second set of the plurality of battery arrays includes at least two or more different battery arrays electrically coupled in parallel.

8. A modular battery system, comprising:
a plurality of battery modules, wherein each battery module of the plurality of battery modules is positioned on a different floor of an enclosure and wherein each battery module of the plurality of battery modules includes a plurality of battery arrays of rechargeable batteries; and
a controller configured to select one of the plurality of battery modules for charging or discharging, wherein the controller is positioned on a different floor of the enclosure from the plurality of battery modules.

9. The modular battery system of claim 8, further comprising:
a first intake duct extending down a first side of the enclosure, wherein the first intake duct is fluidly coupled to a first heating, ventilation, and air conditioning (HVAC) unit to receive a fluid for cooling the plurality of battery modules; and
a central duct fluidly coupled to the first intake duct to remove air from the first intake duct, wherein the central duct is centrally located within the enclosure.

10. The modular battery system of claim 9, wherein the central duct is centrally located in the enclosure.

11. The modular battery system of claim 10, wherein the central duct is coupled to an exhaust vent at a roof of the enclosure for release of air from the central duct.

12. The modular battery system of claim 11, wherein the exhaust vent provides access for maintenance to the plurality of battery modules.

13. The modular battery system of claim 12, further comprising:
a second intake duct extending down a second, different side of the enclosure, wherein the second intake duct is fluidly coupled to a second HVAC unit to receive fluid for cooling the plurality of battery modules.

14. The modular battery system of claim 13, wherein the second intake duct is fluidly coupled to the central duct, wherein the central duct is configured to remove air from the second intake duct.

15. The modular battery system of claim 14, further comprising:
a first intake vent positioned on the roof of the enclosure, wherein the first intake vent is fluidly coupled to the first intake duct and to the first HVAC unit; and
a second intake vent positioned on the roof of the enclosure, wherein the second intake vent is fluidly coupled to the second intake duct and to the second HVAC unit.

16. The modular battery system of claim 1, further comprising:
a display on an outside of the enclosure, wherein display includes an indication of a voltage or power level of the modular battery system.

17. A method for operating a modular battery system, comprising:
selecting by a controller one of a plurality of battery modules, wherein each battery module of the plurality of battery modules is positioned on a different floor of an enclosure and wherein each battery module of the plurality of battery modules includes a plurality of battery arrays of rechargeable batteries;
switching an AC input from a power generator to a first one of a plurality of inverters associated with the selected one of the plurality of battery modules;
converting the AC input to a DC input by the first one of the plurality of inverters; and
charging the plurality of battery arrays in the selected one of the plurality of battery modules with the DC input.

18. The method of claim 17, further comprising:
selecting by the controller a first one of the plurality of battery arrays in the selected one of the plurality of battery modules; and
charging the first one of the plurality of battery arrays in the selected one of the plurality of battery modules with the DC input.

19. The method of claim 17, further comprising:
obtaining by the controller a power level for the plurality of battery arrays of each battery module of the plurality of battery modules.

20. The method of claim 19, wherein the controller uses the power level for the plurality of battery arrays of each battery module to select the one of the plurality of battery modules for charging by the DC input.
